(19) United States
(12) Patent Application Publication
(10) Pub. No.: US 2017/0313135 A1
(43) Pub. Date: Nov. 2, 2017

(54) Pneumatic Tire

(71) Applicant: The Yokohama Rubber Co., LTD., Minato-ku, Tokyo (JP)

(72) Inventor: Akihiro Ichimura, Hiratsuka-shi, Kanagawa (JP)

(21) Appl. No.: 15/517,939

(22) PCT Filed: Oct. 5, 2015
(86) PCT No.: PCT/JP2015/078196

§ 371 Date: Apr. 7, 2017

(30) Foreign Application Priority Data
Oct. 9, 2014 (JP) 2014-207970

(51) Int. Cl. B60C 11/03; B60C 1/00; B60C 9/18

(52) U.S. Cl. CPC B60C 11/0302; B60C 9/18; B60C 1/0008; B60C 1/0016

(57) ABSTRACT

A pneumatic tire includes a narrow groove disposed on a vehicle outer side of a tire equator in the tread portion extending in the tire circumferential direction, wherein the narrow groove has a groove width of from 1 mm to 6 mm; and a plurality of lug grooves disposed in the tread portion that intersect with the narrow groove and include terminating ends on opposite sides, wherein the plurality of lug grooves are each curved toward one side in the tire circumferential direction.

### TECHNICAL FIELD

The present technology relates to a pneumatic tire, and more specifically relates to a pneumatic tire capable of achieving good wet performance, dry performance, uneven wear resistance performance, and noise performance in a highly compatible manner.

### BACKGROUND ART

There is a demand for conventional pneumatic tires to be enhanced in a highly compatible manner in terms of dry performance (for example, steering stability performance and travel time on dry road surfaces) and wet performance (for example, steering stability performance and hydroplaning resistance performance on wet road surfaces). Enhancements in terms of tire wear resistance performance (in particular uneven wear) and noise performance (for example, pass-by noise) are also demanded in addition to these performances.

One known method of improving wet performance includes disposing a plurality of grooves in a tread portion of a pneumatic tire to improve drainage properties. However, by simply increasing the number of grooves, tread rigidity decreases and thus sufficient dry performance and uneven wear resistance performance cannot be obtained. Additionally, depending on the shape and arrangement of the grooves, pass-by noise is more likely to be caused thus decreasing noise performance. This shows that the number, shape, and arrangement of grooves need to be considered in enhancing the various performances in a compatible manner.

Japanese Unexamined Patent Application Publication No. 2010-215221A, as illustrated in FIG. 5, describes a configuration in which a narrow groove with a groove width less than that of a main groove is disposed in a vehicle outer side region which greatly influences dry performance and uneven wear resistance performance. By increasing tread rigidity in this region, dry performance and uneven wear resistance performance is effectively enhanced. Additionally, the reduction in wet performance caused by the narrow groove width of the narrow groove is offset by disposing lug grooves that intersects with the narrow groove with one end terminating within a land portion and the other end reaching a ground contact edge. Note that in the tread pattern of FIG. 5, three main grooves (with one disposed in the vehicle outer side region) are disposed on the vehicle inner side of the narrow groove, and lug grooves are disposed in land portions defined by the main grooves, with an end portion on the vehicle inner side reaching the ground contact edge or the main groove and an end portion on the vehicle outer side terminating within the land portion. As a result, the various performances can be achieved in a compatible manner in regions other than the region near the narrow groove.

However, with increasing demands for faster vehicle speeds brought about by developments in high performance vehicles and road conditions in recent years, such conventional tread pattern configurations are increasingly unable to provide sufficient performance in a compatible manner especially when vehicles are travelling at high speeds. Additionally, in extreme driving environments such as circuit driving, the level of performance demanded is so high that such conventional tread pattern configurations are becoming insufficient. Thus, there is a demand for further enhancements in achieving good wet performance, dry performance, uneven wear resistance performance, and noise performance in a highly compatible manner.

### SUMMARY

The present technology provides a pneumatic tire capable of achieving good wet performance, dry performance, uneven wear resistance performance, and noise performance in a highly compatible manner.

An embodiment of the present technology is a pneumatic tire with a specified mounting direction with respect to a vehicle, the pneumatic tire comprising an annular tread portion that extends in a tire circumferential direction; a pair of sidewall portions disposed on opposite sides of the tread portion; a pair of bead portions disposed inward in a tire radial direction of the pair of sidewall portions; a narrow groove disposed on a vehicle outer side of a tire equator in the tread portion extending in the tire circumferential direction, wherein the narrow groove has a groove width of from 1 mm to 6 mm; and a plurality of lug grooves disposed in the tread portion that intersect with the narrow groove and include terminating ends on opposite sides, wherein the plurality of lug grooves are each curved toward one side in the tire circumferential direction.

According to an embodiment of the present technology, a narrow groove is disposed on the vehicle outer side of the tire equator. This provides sufficient drainage properties without greatly reducing rigidity in the region where the narrow groove is disposed. As a result, good wet performance can be obtained while maintaining good dry performance. Additionally, the lug grooves intersect the narrow groove and include ends on opposite sides that terminate within the land portions. By not dividing the land portions defined by the narrow groove that extend in the circumferential direction, tread rigidity is increased which is advantageous in improving dry performance. Furthermore, the opposite end portions of the lug grooves terminate within the land portions. This stops noise caused by the narrow groove radiating to the vehicle outer side, thus enabling pass-by noise to be reduced and improving noise performance. Also, the lug grooves are curved towards one side in the tire circumferential direction. As a result, the force applied to the lug grooves, which is susceptible to damage when braking/driving or when turning, is distributed, and it is thus possible to effectively suppress uneven wear.

An embodiment of the present technology preferably further comprises a first main groove disposed on the tire equator of the tread portion or on the vehicle outer side of the tire equator at a position on a vehicle inner side of the narrow groove, wherein the first main groove extends in the tire circumferential direction and has a larger groove width than the narrow groove. By disposing such a first main groove, water can be efficiently discharged, and thus wet performance can be improved.

In such an embodiment, the groove width of the narrow groove is preferably from 10% to 60% of the groove width of the first main groove. Additionally, the groove width of the first main groove is preferably from 8 mm to 16 mm. Such a groove width allows for a good balance between the groove widths of the narrow groove and the first main groove, which is advantageous in achieving good wet performance and dry performance in a compatible manner.

In an embodiment of the present technology, a curved portion of the lug groove preferably has a radius of curvature of from 8 mm to 50 mm. The lug groove having such a curved shape is advantageous in enhancing uneven wear resistance performance and noise performance.

In an embodiment of the present technology, a length in a tire width direction of the lug groove is preferably from 0.1% to 5% of a ground contact width of the tread portion. A lug groove with such a form is advantageous in achieving good dry performance and wet performance in a compatible manner.

An embodiment of the present technology further comprises a second main groove disposed on the vehicle inner side of the tire equator in the tread portion extending in the tire circumferential direction, and a third main groove disposed on the vehicle inner side of the second main groove in the tread portion extending in the tire circumferential direction. By disposing main grooves on the vehicle inner side as such, sufficient drainage properties can be ensured and superior wet performance can be obtained for a pneumatic tire with a large tire width.

In an embodiment of the present technology, the second main groove and the third main groove preferably have a groove width of from 8 mm to 16 mm. By setting the dimensions of the main grooves as such, the groove widths of the grooves are contained in a predetermined range, which is advantageous in achieving good wet performance and dry performance in a compatible manner.

In the present technology, each dimension is measured with the tire assembled onto a regular rim and inflated to a regular internal pressure. A “regular rim” is a rim defined by a standard for each tire according to a system of standards that includes standards on which tires are based, and refers to a “standard rim” in the case of Japan Automobile Tyre Manufacturers Association (JATMA), refers to a “design rim” in the case of Tire and Rim Association (TRA), and refers to a “measuring rim” in the case of European Tyre and Rim Technical Organisation (ETRTO). “Regular internal pressure” is the air pressure defined by standards for each tire according to a system of standards that includes standards on which tires are based, and refers to a “maximum air pressure” in the case of JATMA, refers to the maximum value in the table of “TIRE ROAD LIMITS AT VARIOUS COLD INFLATION PRESSURES” in the case of TRA, and refers to the “INFLATION PRESSURE” in the case of ETRTO. “Regular inner pressure” is 180 kPa for a tire on a passenger vehicle.

In the present technology, “ground contact width” is the length in the tire axial direction between opposite end portions (ground contact edges) in the tire axial direction when the tire is assembled on a regular rim and inflated to the regular internal pressure, and placed vertically upon a flat surface with a regular load applied thereto. “Regular load” is the load defined by standards for each tire according to a system of standards that includes standards on which tires are based, and refers to “maximum load capacity” in the case of JATMA, to the maximum value in the table of “TIRE ROAD LIMITS AT VARIOUS COLD INFLATION PRESSURES” in the case of TRA, and to “LOAD CAPACITY” in the case of ETRTO. If the tire is for use with a passenger vehicle, a load corresponding to 88% of the loads described above is used.

### BRIEF DESCRIPTION OF DRAWINGS

FIG. 1 is a meridian cross-sectional view of a pneumatic tire according to an embodiment of the present technology.

FIG. 2 is a front view illustrating a tread surface on a vehicle outer side of a pneumatic tire according to an embodiment of the present technology.

FIG. 3 is a cross-sectional view illustrating an enlarged cross-sectional view of a narrow groove of the pneumatic tire of FIG. 1.

FIG. 4 is a front view illustrating an example of a tread surface of a pneumatic tire according to another embodiment of the present technology.

FIG. 5 is a front view illustrating a tread surface of a conventional pneumatic tire.

### DETAILED DESCRIPTION

Embodiments of the present technology will be described in detail below with reference to the accompanying drawings. Note that in the present technology, the mounting direction of the pneumatic tire with respect to a vehicle is specified. When the pneumatic tire is mounted on a vehicle, the inner side (side indicated in the drawings by “IN”) with respect to the vehicle of a tire equator CL is defined as the “vehicle inner side” and the outer side (side indicated in the drawings by “OUT”) with respect to the vehicle of the tire equator CL is defined as the “vehicle outer side”.

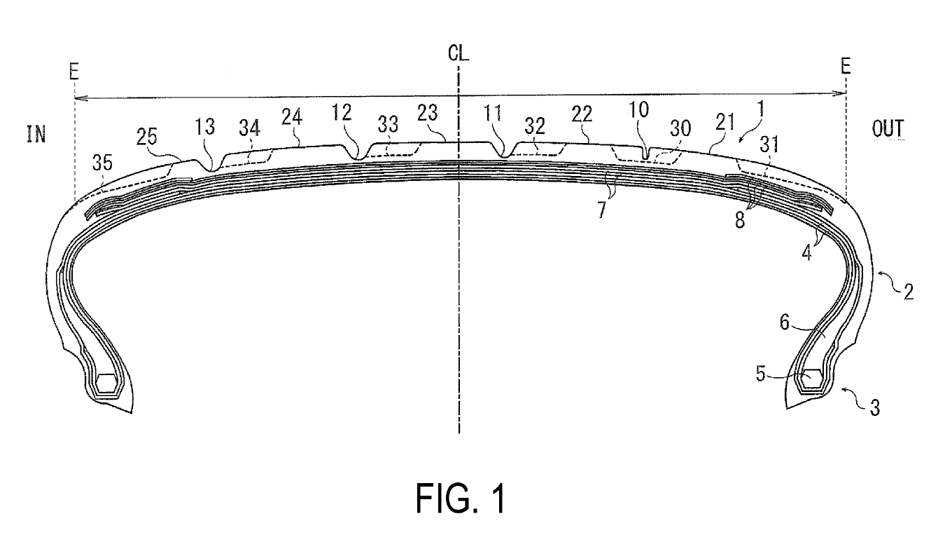

The reference sign CL in FIG. 1 denotes the tire equator. The pneumatic tire of an embodiment of the present technology is provided with an annular tread portion 1 extending in a tire circumferential direction, a pair of sidewall portions 2 disposed on opposite sides of the tread portion 1, and a pair of bead portions 3 disposed inward in a tire radial direction of the sidewall portions 2. A carcass layer 4 (two layers in FIG. 1) extends between the left-right pair of bead portions 3. The carcass layer 4 includes a plurality of reinforcing cords extending in a tire radial direction, and is folded back around a bead core 5 disposed in each bead portion 3 from a vehicle inner side to vehicle outer side. Additionally, a bead filler 6 is disposed on a periphery of each of the bead cores 5, and the bead filler 6 is enveloped by a main portion and the folded-back portion of the carcass layer 4. In the tread portion 1, a plurality of belt layers 7 (two layers in FIG. 1) are embedded on the outer circumferential side of the carcass layer 4. Each of the belt layers 7 includes a plurality of reinforcing cords inclined with respect to the tire circumferential direction, and the direction of the reinforcing cords of the different layers intersect each other. In the belt layers 7, the inclination angle of the reinforcing cords with respect to the tire circumferential direction ranges from 10° to 40° for example. A plurality of belt reinforcing layers 8 (three layers in FIG. 1) are disposed on the outer circumferential side of the belt layers 7. As illustrated in FIG. 1, the belt reinforcing layers 8 may include layers that only cover the end portions of the belt layers 7. The belt reinforcing layers 8 include organic fiber cords oriented in the tire circumferential direction. In the belt reinforcing layers 8, the angle of the organic fiber cords with respect to the tire circumferential direction is from 0° to 5° for example.

The present technology may be applied to such a general pneumatic tire, however, the internal structure is not limited to the basic structure described above.

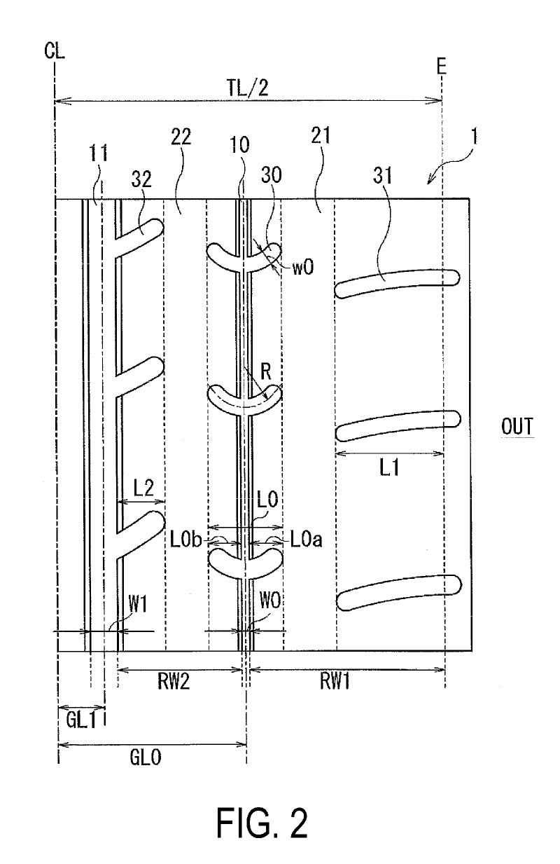

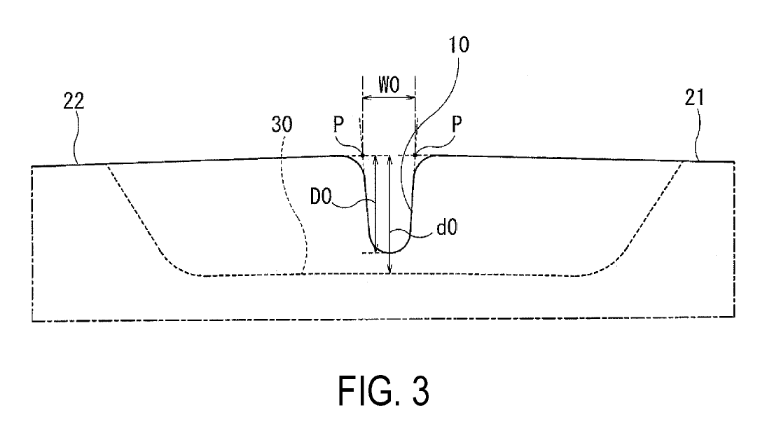

As illustrated in FIGS. 2 and 3, one narrow groove 10 that extends in the tire circumferential direction is disposed on the vehicle outer side of tire equator CL in the tread portion 1. The narrow groove 10 has a groove width W0 of from 1 mm to 6 mm. In embodiments in which a main groove extending in the tire circumferential direction is disposed as described below, the narrow groove 10 has a smaller groove width W0 than the main groove. A groove depth D0 of the narrow groove 10 is not particularly limited and can be from 3 mm to 4 mm for example.

Ribs (first rib 21 and second rib 22 in FIG. 2) are defined by the narrow groove 10. A plurality of lug grooves 30 that extend in the tire width direction are disposed in the ribs at intervals in the tire circumferential direction. The lug grooves 30 each intersect the narrow groove 10. The lug groove 30 is curved toward one side in the tire circumferential direction and includes one end portion that terminates within the first rib 21 and another end portion that terminates within the second rib 22. A groove width w0 and a groove depth d0 of the lug groove 30 are not particularly limited. The groove width w0 can be from 7 mm to 15 mm, and the groove depth d0 can be from 3 mm to 6 mm for example. As illustrated in FIG. 3, the groove depth d0 of the lug groove 30 may be greater than the groove depth D0 of the narrow groove 10.

In such a manner, by disposing the narrow groove 10 with a groove width of from 1 mm to 6 mm at a position on the vehicle outer side of the tire equator CL, tread rigidity at the vehicle outer side region which greatly influences dry performance (in particular steering stability performance on dry road surfaces) is not reduced. Accordingly, the narrow groove 10 can provide sufficient drainage properties and thus superior wet performance while maintaining dry performance. In particular, the narrow groove 10 with a groove width in the range described above allows good dry performance and wet performance to be achieved in a compatible manner. Additionally, the end portions of the lug groove 30 disposed intersecting the narrow groove 10 terminate within the corresponding first rib 21 and the second rib 22, and the first rib 21 and the second rib 22 defined by the narrow groove 10 is not divided by the lug grooves 30 (in FIG. 2, the ribs are continuous around the entire circumference). This results in increased tread rigidity which is advantageous in improving dry performance. Furthermore, the lug groove 30 terminates without reaching a ground contact edge E. This stops noise caused by the narrow groove 10 radiating to the vehicle outer side, thus enabling pass-by noise to be reduced and improving noise performance. Also, the lug groove 30 is curved towards one side in the tire circumferential direction. As a result, the force applied to the lug groove 30, which is susceptible to damage when braking/driving or when turning, is distributed, and it is thus possible to suppress uneven wear.

If the groove width W0 of the narrow groove 10 is less than 1 mm, the narrow groove 10 cannot be ensured sufficient groove volume and obtaining sufficient wet performance become problematic. If the groove width W0 of the narrow groove 10 is greater than 6 mm, tread rigidity decreases, thus reducing dry performance. In a similar manner, if the groove depth D0 of the narrow groove 14 if less than 3 mm, the narrow groove 10 cannot be ensured sufficient groove volume and obtaining sufficient wet performance becomes problematic. If the groove depth D0 of the narrow groove 14 is greater than 6 mm, tread rigidity decreases, and maintaining sufficient dry performance becomes problematic.

If the end portions of the lug groove 30 do not terminate within the corresponding land portions on either side of the narrow groove 10 (first rib 21 and second rib 22) and reach the groove (first main groove 11 in FIG. 2) that extends adjacent to the narrow groove 10 in the circumferential direction or the ground contact edge E, the land portion (first rib 21 and second rib 22) adjacent to the narrow groove 10 is divided. As a result, tread rigidity decreases, and improving dry performance becomes problematic. In particular, if the end portions reach the ground contact edge E, noise performance decreases. If the lug groove 30 is not curved toward one side in the circumferential direction and extends linearly in the tire width direction, the force applied to the lug groove 30 is distributed and an effect of suppressing uneven wear cannot be sufficiently obtained.

As illustrated in FIG. 2, a first main groove 11 that extends in the tire circumferential direction is disposed on the vehicle outer side of the tire equator CL in the tread portion 1, in addition to the narrow groove 10 and the lug grooves 30. As illustrated in FIG. 2, the first main groove 11 is preferably disposed on the vehicle outer side of the tire equator CL at a position on the vehicle inner side (side proximal to the tire equator CL) of the narrow groove 10. Alternatively, the first main groove 11 may be disposed on the tire equator CL. By disposing such a first main groove 11, water can be efficiently discharged from the region near the tire equator CL of the tread portion 1, and thus wet performance can be improved. Note that in embodiments in which the first main groove 11 is disposed, the second rib 22 described above corresponds to a land portion defined by the narrow groove 10 and the first main groove 11.

Grooves (in FIG. 2, first lug grooves 31 and second lug grooves 32) that extend in the tire width direction may be disposed in the first rib 21 and the second rib 22, in addition to the lug grooves 30 described above. In the embodiment illustrated in FIG. 2, the first lug grooves 31 are disposed in the first rib 21. The first lug grooves 31 each have one end reaching the ground contact edge E on the vehicle outer side and the other end terminating within the first rib 21 without communicating with the narrow groove 14. The second lug grooves 32 are disposed in the second rib 22. The second lug grooves 32 each have one end communicating with the first main groove 11 and the other end terminating within the second rib 22.

In embodiments with a first main groove 11 such as that illustrated in FIG. 2, the first main groove 11 has a greater groove width than the narrow groove 10. The groove width W0 of the narrow groove 10 is preferably from 10% to 60% of a groove width W1 of the first main groove 11. This provides a good balance between the groove width W0 of the narrow groove 10 and the groove width W1 of the first main groove 11, which is advantageous in achieving superior wet performance and dry performance in a compatible manner. If the groove width W0 of the narrow groove 10 is less than 10% of the groove width W1 of the first main groove 11, drainage properties provided by the narrow groove 10 are not sufficient and improving wet performance becomes problematic. If the groove width W0 of the narrow groove 10 is greater than 60% of the groove width W1 of the first main groove 11, maintaining a high level of rigidity at the land portion adjacent to the narrow groove 10 becomes problematic, and thus does improving dry performance. The groove depth of the first main groove 11 is not particularly limited, but is preferably greater than the groove depth D0 of the narrow groove 10. In particular, to provide a good balance between the groove depth D0 of the narrow groove 10 and the groove depth of the first main groove 11, the groove depth D0 of the narrow groove 10 is preferably from 60% to 80% of the groove depth of the first main groove 11.

Additionally, the groove width W1 of the first main groove 11 is preferably 8 mm or greater to obtain sufficient wet performance. However, if the groove width is excessive, the groove portion becomes prone to buckling due to lateral forces when cornering. Thus, the groove width W1 is preferably 16 mm or less. The groove width of the first main groove 11 is more preferably from 10 mm to 14 mm. The groove depth of the first main groove 11 is preferably 5 mm or greater to obtain sufficient wet performance. However, if the groove depth is excessive, tread rigidity decreases and sufficiently improving dry performance becomes problematic. Thus, the groove depth is preferably 7 mm or less. A groove depth D1 of the first main groove 11 is more preferably from 5.5 mm to 7.5 mm.

As illustrated in FIG. 2, in embodiments with the first main groove 11 as well as the narrow groove 10 such as that illustrated in FIG. 2, the distance from the center position of the narrow groove 10 to the position of the tire equator CL is defined as GL0, and the distance from the center position of the first main groove 11 to the position of the tire equator CL is defined as GL1. The narrow groove 10 is preferably disposed so that the distance GL0 is from 40% to 60% of a half-width TL/2 of a tire ground contact width TL. The first main groove 11 is preferably disposed so that the distance GL1 is from 0% to 20% of the half-width TL/2 of the tire ground contact width TL. Such an arrangement provides a good balance between the widths of the land portions (the first rib 21 and the second rib 22) defined by the narrow groove 10 and the first main groove 11. As a result, good wet performance and dry performance can be obtained.

The curved portion of the lug groove 30 preferably has a radius of curvature R of from 8 mm to 50 mm. The lug groove 30 having such a curved shape is advantageous in enhancing uneven wear resistance performance and noise performance. If the radius of curvature R is less than 8 mm, the lug groove 30 cannot be ensured sufficient length in the tire width direction, and thus no significant effect can be obtained from disposing the lug groove 30. If the radius of curvature R is greater than 50 mm, the shape of the lug groove 30 is roughly rectilinear in the tire width direction. This makes sufficiently obtaining the effects of a curved lug groove 30 problematic. Note that the radius of curvature R of the lug groove 30, as illustrated in FIG. 2, is a value measured using the center line (dot-dash line) of the lug groove 30.

A length L0 in the tire width direction of the lug groove 30 is preferably from 1% to 6% of the ground contact width TL of the tread portion 1. A lug groove 30 with such a form is advantageous in achieving good dry performance and wet performance in a compatible manner. If the length L0 is less than 1% of the ground contact width TL, the lug groove 30 cannot be ensured sufficient groove volume, and thus obtaining superior wet performance becomes problematic. If the length L0 is greater than 6% of the ground contact width TL, the proportion of the length in the width direction in the land portion adjacent to the narrow groove 10 that the lug groove 30 takes up is excessive. As a result, land portion rigidity is insufficient and improving dry performance becomes problematic.

Additionally, as illustrated in FIG. 2, the lug groove 30 has one end that terminates within the first rib 21 and another end that terminates within the second rib 22. The length on the side of one end (the length in the tire width direction from an outer wall face in the tire width direction of the narrow groove 10 to the terminating position within the first rib 21) is defined as L0a, and the length on the side of the other end (the length in the tire width direction from a wall face proximal to the tire equator CL of the narrow groove 10 to the terminating position within the second rib 22) is defined as L0b. The length L0a is preferably from 5% to 25% of a width RW1 of the first rib 21, and the length L0b is preferably from 15% to 45% of a width RW2 of the second rib 22. Note that as illustrated in FIG. 2, the width RW1 of the first rib 21 is the length from the narrow groove 10 to the ground contact edge E.

As illustrated in FIG. 2, in embodiments in which a groove (the first lug groove 31 or the second lug groove 32) extending in the tire width direction is disposed in addition to the lug groove 30, the position where the lug groove 30 and the narrow groove 10 intersect and the position where the first lug groove 31 meets the ground contact edge are preferably offset in the tire circumferential direction. Additionally, the position where the lug groove 30 and the narrow groove 10 intersect and the position where the second lug groove opens to the first main groove 11 are preferably offset in the tire circumferential direction. Furthermore, a line that joins the point where the lug groove 30 and the narrow groove 10 intersect and the end portion of the lug groove 30 on the first rib 21 side is preferably orientated in the same direction as the inclination direction of the first lug groove 31. Also, a line that joins the point where the lug groove 30 and the narrow groove 10 intersect and the end portion of the lug groove 30 on the second rib 22 side is preferably orientated in the direction opposite the inclination direction of the second lug groove 32. Such an arrangement is advantageous in achieving good wet performance and dry performance in a compatible manner.

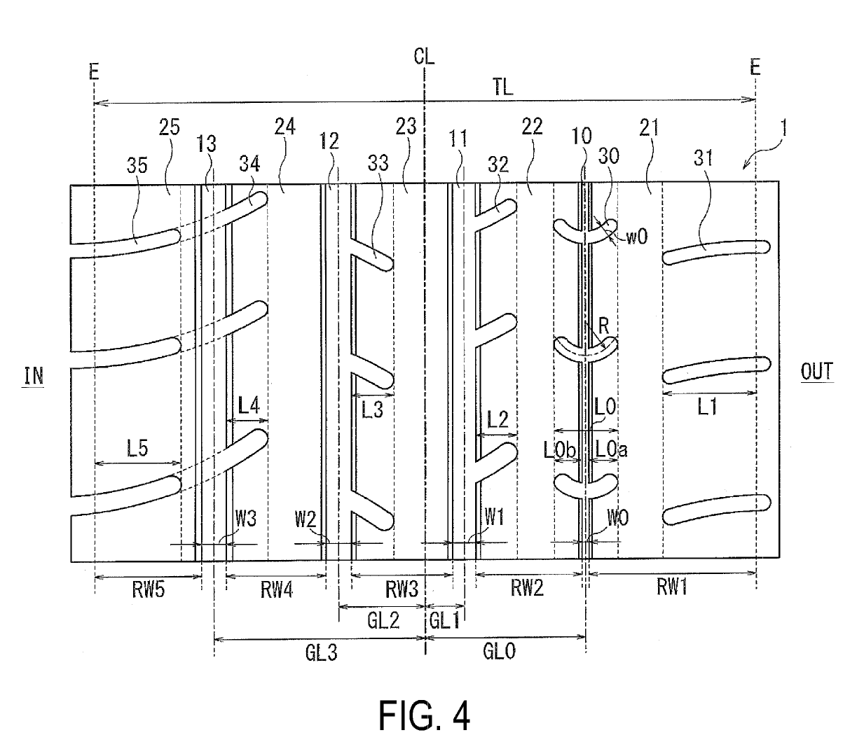

The tread pattern of the tread portion 1 on the vehicle inner side of the tire equator CL is not particularly limited. For example, as illustrated in FIG. 4, a second main groove 12 that extends in the tire circumferential direction is preferably disposed at a position on the vehicle inner side of the tire equator CL in the tread portion 1, and a third main groove 13 that extends in the tire circumferential direction is preferably disposed at a position on the vehicle inner side of the second main groove 12 in the tread portion 1. By disposing main grooves on the vehicle inner side as such, sufficient wet performance can be ensured for a pneumatic tire with a large tire width.

In such an embodiment, to obtain sufficient wet performance, groove width W2 of the second main groove 12 and groove width W3 of the third main groove 13 are preferably 8 mm or greater, similar to the first main groove 11. However, if the groove width is excessive, the groove portion becomes prone to buckling due to lateral forces when cornering. Thus, the groove width is preferably 16 mm or less. The groove width W2 of the second main groove 12 and the groove width W3 of the third main groove 13 are more preferably from 10 mm to 14 mm. Additionally, to obtain sufficient wet performance, groove depth D2 of the second main groove 12 and groove depth D3 of the third main groove 13 are preferably 5 mm or greater, similar to the first main groove 11. However, if the groove depth is excessive, tread rigidity decreases and sufficiently improving dry performance becomes problematic. Thus, the groove depth is preferably 7 mm or less. The groove depth D2 of the second main groove 12 and the groove depth D3 of the third main groove 13 are more preferably from 5.5 mm to 7.5 mm.

By disposing the second main groove 12 and the third main groove 13 as such, a third rib 23 is defined on the tire equator CL side of the second main groove 12 (between the second main groove 12 and the first main groove 11), a fourth rib 24 is defined between the second main groove 12 and the third main groove 13, and a fifth rib 25 is defined on the vehicle inner side of the third main groove 13. In the third rib 23, fourth rib 24, and fifth rib 25, a plurality of lug grooves (third lug groove 33, fourth lug groove 34, and fifth lug groove 35) that differ from the curved lug groove 30 described above can be disposed. In the embodiment illustrated in FIG. 4, the third lug groove 33 includes one end communicating with the second main groove 12 and the other end terminating within the third rib 23. The fourth lug groove 34 includes one end communicating with the third main groove 13 and the other end terminating within the fourth rib 24. The fifth lug groove 35 includes one end that reaches the ground contact edge E on the vehicle inner side and the other end terminating within the fifth rib 25 without communicating with the third main groove 13.

Note that in the embodiment illustrated in FIG. 4, the fifth lug groove 35 and the fourth lug groove 34 have an arrangement in which the fourth lug groove 34 is disposed on an extension line of the fifth lug groove 35, as illustrated by the dotted line in FIG. 4. Additionally, the second lug groove 32 and the third lug groove 33 have an arrangement in which, to improve uniformity and balance tread rigidity, each opening portion is offset in the tire circumferential direction. In a similar manner, the opening portions of the third lug groove 33 and the fourth lug groove 34 are offset in the tire circumferential direction. In particular, in the embodiment illustrated in FIG. 4, the second lug grooves 32 and the third lug grooves 33 are alternately disposed in the tire circumferential direction, and the third lug grooves 33 and the fourth lug grooves 34 are alternately disposed along the tire circumferential direction. Furthermore, in the embodiment illustrated in FIG. 4, the inclination directions of the second lug groove 32, the third lug groove 33, and the fourth lug groove 34, which are inclined with respect to the tire width direction, are such that the second lug groove 32 and the third lug groove 33 are opposite and the third lug groove 33 and the fourth lug groove 34 are opposite.

In an embodiment with a tread pattern such as that illustrated in FIG. 4, the distance from the center position of the second main groove 12 to the tire equator CL is defined as GL2, and the distance from the center position of the third main groove 13 to the tire equator CL is defined as GL3. The second main groove 12 is preferably disposed so that the distance GL2 is from 20% to 35% of the half-width TL/2 of the tire ground contact width TL. The third main groove 13 is preferably disposed so that the distance GL3 is from 55% to 70% of the half-width TL/2 of the tire ground contact width TL. Such an arrangement provides a good balance between the widths of the land portions (the third rib 23, the fourth rib 24, and the fifth rib 25) defined by the second main groove 12 and the third main groove. As a result, wet performance and dry performance can be enhanced.

As illustrated in FIG. 4, in embodiments in which the first lug groove 31, the second lug groove 32, the third lug groove 33, the fourth lug groove 34, and the fifth lug groove 35 are disposed as well as the curved lug groove 30, the lug grooves preferably do not divide the land portions (the first rib 21, the second rib 2, the third rib 23, the fourth rib 24, and the fifth rib 25) as described above. In particular, the terminating position (length of the lug grooves with respect to the width of the rib) of the lug grooves are preferably set as described below. In other words, a length L1 of the first lug groove 31 is preferably from 80% to 90% of the width RW1 of the first rib 21; a length L2 of the second lug groove 32 is preferably from 30% to 50% of the width RW2 of the second rib 22; a length L3 of the third lug groove 33 is preferably from 30% to 50% of the width RW3 of the third rib 23; a length L4 of the fourth lug groove 34 is preferably from 30% to 50% of the width RW4 of the fourth rib 24; and a length L5 of the fifth lug groove 35 is preferably from 50% to 80% of the width RW5 of the fifth rib 25. In embodiments with such an arrangement, the length of the third lug groove 33 is preferably such that the third lug groove 33 terminates in the region of the third rib 23 on the vehicle inner side without reaching the tire equator CL. Note that the width RW1 of the first rib 21 and the width RW5 of the fifth rib 25 are the length from the third main groove 13/narrow groove 14 to the respective ground contact edge E, as illustrated in FIG. 2.

In the embodiment illustrated in FIG. 4, the groove depth of the first lug groove 31, the second lug groove 32, the third lug groove 33, the fourth lug groove 34, and the fifth lug groove 35 disposed in the tread portion 1 is not particularly limited. However, the groove depth is preferably less than that of the main grooves (the first main groove 11, the second main groove 12, and the third main groove 13) and greater than the groove depth of the narrow groove 10. The groove depth is more preferably 80% or greater of the groove depth of the narrow groove 10 and 100% or less of the groove depth of the first main groove 11.

In the embodiment illustrated in FIG. 4 in which a plurality of grooves are disposed as well as the narrow groove 10 and the lug groove 30, the groove area ratio of the region of the tread portion 1 on the vehicle outer side of the tire equator CL (the groove area ratio on the vehicle outer side) is preferably relatively less than the groove area ratio of the region of the tread portion 1 on the vehicle inner side of the tire equator CL (the groove area ratio on the vehicle inner side). In particular, the groove area ratio on the vehicle outer side preferably ranges from 8% to 25%, and the groove area ratio on the vehicle inner side preferably ranges from 22% to 40%. Setting the groove area ratios as such is advantageous in achieving good wet performance and dry performance in a compatible manner.

Note that the groove area ratios in both regions described above are groove area ratios specified for the regions within the ground contact region of the tread portion 1. The groove surface area ratio is a ratio (%) of a total area of groove portions within the regions with respect to a total area including the land portions and the groove portions of the regions. The ground contact region of the tread portion 1 is the region defined by the ground contact width described above.

The narrow groove 10 is preferably chamfered as illustrated in the enlarged view of FIG. 3. This enables sufficient groove area (groove volume) of the narrow groove 10 to be ensured in the initial period of wear without increasing the groove width. As a result, tread rigidity can be ensured, and thus superior wet performance can be obtained while maintaining dry performance. A portion from 1 mm to 2 mm from the corner portion where the groove wall and the tread surface meet is preferably removed. In particular, the edge is preferably radiused. Note that in embodiments in which the narrow groove 10 is chamfered as such, as illustrated in FIG. 3, the groove width and the groove depth of the narrow groove 10 are measured using the point of intersection P of an extension line of the groove wall and an extension line of the tread surface. Additionally, in embodiments in which grooves that extend in the tire circumferential direction (for example, the first main groove 11, the second main groove 12, and the third main groove 13 illustrated in FIG. 4) are disposed as well as the narrow groove 10, these grooves that extend in the tire circumferential direction are preferably chamfered in a similar manner to the narrow groove 10.

### Examples

Seventeen types of pneumatic tires corresponding to Conventional Example 1, Comparative Examples 1 and 2, and Examples 1 to 14 were manufactured. The tire size was 285/35ZR20 and the tires all included the reinforcement structure illustrated in FIG. 1. Other specifications including base tread pattern, groove width of the narrow groove and the first to third main grooves (for the narrow groove, the ratio with respect to the first main groove is also indicated), distance from the tire equator of the narrow groove and the first to third main grooves (ratio with respect to the half-width TL/2 of the ground contact width), length L0 in the tire width direction of the lug groove (ratio with respect to the ground contact width TL), length L0a in the tire width direction of the portion of the lug groove on the side where the first rib is disposed (ratio with respect to the width of the first rib), length in the tire width direction of the portion of the lug groove on the side where the second rib is disposed (ratio with respect to the width of the first rib), shape of the lug groove, and radius of curvature of the lug groove were set as indicated in Tables 1 and 2.

Note that common to the examples with the base tread pattern illustrated in FIG. 2, the length L1 in the tire width direction of the first lug groove is 55% the width RW1 of the first rib; the length L2 in the tire width direction of the second lug groove is 40% the width RW2 of the second rib; the length L3 in the tire width direction of the third lug groove is 40% the width RW3 of the third rib; the length L4 in the tire width direction of the fourth lug groove is 40% the width RW4 of the fourth rib; and the length L5 in the tire width direction of the fifth lug groove is 80% the width RW5 of the fifth rib. Additionally, the depth of the first to third main grooves is 5.5 mm, the depth of the narrow groove is 4.5 mm, and the depth of the lug groove and the first to fifth lug grooves is 5.5 mm.

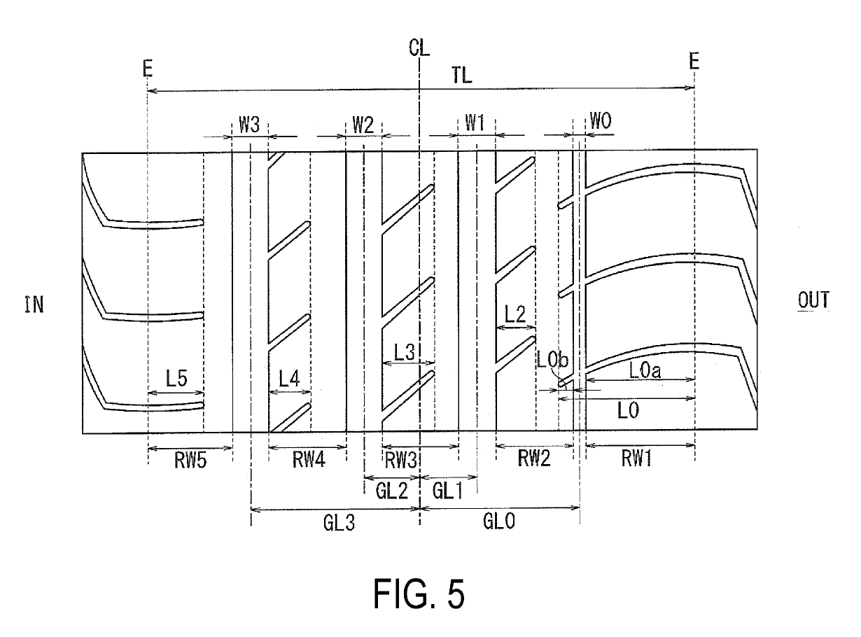

Conventional Example 1 has the tread pattern illustrated in FIG. 5. This tread pattern is different from that of Comparative Examples 1 to 4 and Examples 1 to 16. However, the main groove on the vehicle outer side of the tire equator corresponding to the first main groove, the main groove on the vehicle inner side of the tire equator corresponds to the second main groove, the main groove on the vehicle inner side of the second main groove corresponds to the third main groove, and the groove on the vehicle outer side of the first main groove corresponds to the narrow groove. The distances from the center position to the tire equator of these grooves corresponds to GL1, GL2, GL3, GL0. Additionally, the groove widths of these grooves correspond to W1, W2, W3, W0. In a similar manner, the land portion on the vehicle outer side of the narrow groove corresponds to the first rib, the land portion between the first main groove and the narrow groove corresponds to the second rib, the land portion between the second main groove and the first main groove corresponds to the third rib, the land portion between the third main groove and the second main groove corresponds to the fourth rib, and the land portion on the vehicle inner side of the third main groove corresponds to the fifth rib. The widths of these portions correspond to RW1 to RW5. The example illustrated in FIG. 5 has a significantly different shape near the narrow groove to the example illustrated in FIG. 4. However, for the sake of convenience, in FIG. 5, the groove with one end intersecting the narrow groove and terminating within the second rib and the other end reaching the ground contact edge corresponds to the lug groove. The length of this groove corresponds to L0. Furthermore, the lug groove disposed in the second rib with one end communicating with the first main groove corresponds to the second lug groove, the lug groove disposed in the third lug groove corresponds to the third lug groove, the lug groove disposed in the fourth lug groove corresponds to the fourth lug groove, and the lug groove disposed in the fifth lug groove with one end terminating within the fifth rib and the other end reaching the ground contact edge corresponds to the fifth lug groove. The lengths of these grooves correspond to L2 to L5 (in other words, in FIG. 5, the groove corresponding to the first lug groove of FIG. 4 is not present).

In Conventional Example 1 (with the base tread pattern of FIG. 5), the length L2 in the tire width direction of the second lug groove is 35% the width RW2 of the second rib, the length L3 in the tire width direction of the third lug groove is 45% the width RW3 of the third rib, the length L4 in the tire width direction of the fourth lug groove is 55% the width RW4 of the fourth rib, and the length L5 in the tire width direction of the fifth lug groove is 80% the width RW5 of the fifth rib. Additionally, the depth of the first to third main grooves is 8.0 mm, the depth of the narrow groove is 7.5 mm, and the depth of the lug groove and the first to fifth lug grooves is 6.5 mm.

These 17 types of pneumatic tire were evaluated using the methods described below for dry performance by measuring steering stability performance and travel time on dry road surfaces, wet performance by measuring steering stability performance and hydroplaning resistance performance on wet road surfaces, uneven wear resistance performance, and noise performance. The results are shown in Tables 1 and 2.

### Dry Performance (Steering Stability Performance)

For each tire, the tires were assembled on a wheel with a rim size of 20×10.5 JJ, inflate to an air pressure of 220 kPa, and mounted on a test vehicle with an engine displacement of 3.8 L. The vehicle was test driven by a test driver on a dry road surface circuit course, and the steering stability performance was measured by sensory evaluation. The evaluation results are scored out of 10 with Conventional Example 1 being given a score of 5 (reference). Higher scores indicate superior dry performance (steering stability performance).

### Dry Performance (Travel Time)

For each tire, the tires were assembled on a wheel with a rim size of 20×10.5 JJ, inflate to an air pressure of 220 kPa, and mounted on a test vehicle with an engine displacement of 3.8 L. The vehicle was driven on a dry road surface circuit course (one lap equaling approximately 4500 km) for seven laps, and the travel time (sec) for one lap was measured for each lap. The fastest travel time measured for one lap was taken as the travel time. The evaluation results were expressed as index values using the inverse value as the measurement value, and Conventional Example 1 being defined as 100. Larger index values indicate less driving time.

Wet performance (steering stability performance) For each tire, the tires were assembled on a wheel with a rim size of 20×10.5 JJ, inflate to an air pressure of 220 kPa, and mounted on a test vehicle with an engine displacement of 3.8 L. The vehicle was test driven by a test driver on a circuit course with water on the surface, and the steering stability performance was measured by sensory evaluation. The evaluation results are scored out of 10 with Conventional Example 1 being given a score of 5 (reference). Higher scores indicate superior wet performance (steering stability).

### Wet Performance (Hydroplaning Resistance Performance)

For each tire, the tires were assembled on a wheel with a rim size of 20×10.5 JJ, inflate to an air pressure of 220 kPa, and mounted on a test vehicle with an engine displacement of 3.8 L. The vehicle was test driven by driving the vehicle into a pool of water with a depth of 10±1 mm on a straight portion of the road. The speed at which the vehicle was driven into the pool was gradually increased. The speed at which hydroplaning occurred was measured as the limiting speed. Evaluation results were expressed as index values with Conventional Example 1 being defined as 100. Larger index values indicate superior hydroplaning resistance performance.

### Wear Resistance Performance

For each tire, the tires were assembled on a wheel with a rim size of 20×10.5 JJ, inflate to an air pressure of 220 kPa, and mounted on a test vehicle with an engine displacement of 3.8 L. The vehicle was test driven by a test driver on a circuit course continuously for 50 km, after which the degree of uneven wear in the tread portion was inspected. Uneven wear resistance performance was evaluated by scoring the degree of uneven wear out of 10 (10: excellent, 9-8: good, 7-6: fair, 5 or less: unsatisfactory). Larger index values indicate superior uneven wear resistance performance.

### Noise Performance

For each tire, the tires were assembled on a wheel with a rim size of 20×10.5 JJ, inflate to an air pressure of 220 kPa, and mounted on a test vehicle with an engine displacement of 3.8 L. The vehicle was driven on a test road surface for measuring external noise in accordance with the ISO, and the pass-by noise when traveling at 80 km/h was measured. The evaluation results were expressed as index values using the inverse value as the measurement value, and Conventional Example 1 being defined as 100. Larger index values indicate lower pass-by noise and superior noise performance.

TABLE 1-1

| | | | Conventional | | | Comparative |
|---|---|---|---|---|---|---|
| | | | Example | Example | Example | Example |
| | | | 1 | 1 | 2 | 1 |
| Base tread pattern | | | FIG. 5 | FIG. 4 | FIG. 4 | FIG. 4 |
| Groove width | W0 | mm | 4 | 4 | 4 | 0.5 |
| | W1 | mm | 20 | 10 | 10 | 10 |
| | W0/W1 | % | 20 | 40 | 40 | 5 |
| | W2 | mm | 15 | 10 | 10 | 10 |
| | W3 | mm | 15 | 10 | 10 | 10 |
| Distance | GL0/(TL/2) | % | 55 | 50 | 50 | 50 |
| | GL1/(TL/2) | % | 20 | 10 | 0 | 10 |
| | GL2/(TL/2) | % | 20 | 25 | 25 | 25 |
| | GL3/(TL/2) | % | 55 | 65 | 65 | 65 |
| Lug groove | Length | % | 25 | 2 | 2 | 2 |
| | L0/TL | | | | | |
| | Length | % | 100 | 15 | 15 | 15 |
| | L0a/RW1 | | | | | |
| | Length | % | 25 | 25 | 25 | 25 |
| | L0b/RW2 | | | | | |
| | Shape | | — | Curved | Curved | Curved |
| | Radius of | mm | — | 10 | 10 | 10 |
| | curvature R | | | | | |
| Dry | Steering | | 5 | 8 | 7 | 8 |
| performance | stability | | | | | |
| | performance | | | | | |
| | Travel time | Index | 100 | 105 | 104 | 105 |
| | | value | | | | |
| Wet | Steering | | 5 | 8 | 8 | 6 |
| performance | stability | | | | | |
| | performance | | | | | |
| | Hydroplaning | Index | 100 | 104 | 104 | 98 |
| | resistance | value | | | | |
| | performance | | | | | |

| | | | | | |
|---|---|---|---|---|---|
| Uneven wear resistance | | 7 | 9 | 7 | 8 |
| performance | | | | | |
| Noise performance | Index | 100 | 102 | 102 | 101 |
| | value | | | | |

TABLE 1-2

| | | | | | Comparative | | |
|---|---|---|---|---|---|---|---|
| | | | Example 3 | Example 4 | Example 2 | Example 5 | Example 6 |
| Base tread pattern | | | FIG. 4 | FIG. 4 | FIG. 4 | FIG. 4 | FIG. 4 |
| Groove width | W0 | mm | 1 | 6 | 10 | 4 | 4 |
| | W1 | mm | 10 | 10 | 10 | 8 | 14 |
| | W0/W1 | % | 10 | 60 | 100 | 50 | 29 |
| | W2 | mm | 10 | 10 | 10 | 8 | 14 |
| | W3 | mm | 10 | 10 | 10 | 8 | 14 |
| Distance | GL0/(TL/2) | % | 50 | 50 | 50 | 50 | 50 |
| | GL1/(TL/2) | % | 10 | 10 | 10 | 10 | 10 |
| | GL2/(TL/2) | % | 25 | 25 | 25 | 25 | 25 |
| | GL3/(TL/2) | % | 65 | 65 | 65 | 65 | 65 |
| Lug groove | Length | % | 2 | 2 | 2 | 2 | 2 |
| | L0/TL | | | | | | |
| | Length | % | 15 | 15 | 15 | 15 | 15 |
| | L0a/RW1 | | | | | | |
| | Length | % | 25 | 25 | 25 | 25 | 25 |
| | L0b/RW2 | | | | | | |
| | Shape | | Curved | Curved | Curved | Curved | Curved |
| | Radius of | mm | 10 | 10 | 10 | 10 | 10 |
| | curvature R | | | | | | |
| Dry | Steering | | 8 | 8 | 6 | 8 | 8 |
| performance | stability | | | | | | |
| | performance | | | | | | |
| | Travel time | Index | 105 | 105 | 102 | 105 | 105 |
| | | value | | | | | |
| Wet | Steering | | 8 | 8 | 9 | 7 | 8 |
| performance | stability | | | | | | |
| | performance | | | | | | |
| | Hydroplaning | Index | 104 | 104 | 105 | 103 | 104 |
| | resistance | value | | | | | |
| | performance | | | | | | |

| | | | | | | |
|---|---|---|---|---|---|---|
| Uneven wear resistance | | 9 | 9 | 6 | 9 | 9 |
| performance | | | | | | |
| Noise performance | Index | 102 | 102 | 100 | 102 | 102 |
| | value | | | | | |

TABLE 2-1

| | | | Example | Example | Example | Example |
|---|---|---|---|---|---|---|
| | | | 7 | 8 | 9 | 10 |
| Base tread pattern | | | FIG. 4 | FIG. 4 | FIG. 4 | FIG. 4 |
| Groove width | W0 | mm | 4 | 4 | 4 | 4 |
| | W1 | mm | 16 | 10 | 10 | 10 |
| | W0/W1 | % | 25 | 40 | 40 | 40 |
| | W2 | mm | 16 | 10 | 10 | 10 |
| | W3 | mm | 16 | 10 | 10 | 10 |
| Distance | GL0/(TL/2) | % | 50 | 50 | 50 | 50 |
| | GL1/(TL/2) | % | 10 | 10 | 10 | 10 |
| | GL2/(TL/2) | % | 25 | 25 | 25 | 25 |
| | GL3/(TL/2) | % | 65 | 65 | 65 | 65 |
| Lug groove | Length L0/TL | % | 2 | 2 | 2 | 2 |
| | Length L0a/RW1 | % | 15 | 15 | 15 | 15 |
| | Length L0b/RW2 | % | 25 | 25 | 25 | 25 |
| | Shape | | Curved | Curved | Curved | Curved |
| | Radius of curvature R | mm | 10 | 5 | 8 | 50 |
| Dry | Steering stability | | 7 | 8 | 8 | 8 |
| performance | performance | | | | | |
| | Travel time | Index | 104 | 105 | 105 | 105 |
| | | value | | | | |
| Wet | Steering stability | | 8 | 7 | 8 | 8 |
| performance | performance | | | | | |
| | Hydroplaning | Index | 104 | 103 | 104 | 104 |
| | resistance performance | value | | | | |

| | | | | | |
|---|---|---|---|---|---|
| Uneven wear resistance performance | | 8 | 8 | 9 | 9 |
| Noise performance | Index | 102 | 101 | 102 | 102 |
| | value | | | | |

TABLE 2-2

| | | | Example | Example | Example | Example |
|---|---|---|---|---|---|---|
| | | | 11 | 12 | 13 | 14 |
| Base tread pattern | | | FIG. 4 | FIG. 4 | FIG. 4 | FIG. 4 |
| Groove width | W0 | mm | 4 | 4 | 4 | 4 |
| | W1 | mm | 10 | 10 | 10 | 10 |
| | W0/W1 | % | 40 | 40 | 40 | 40 |
| | W2 | mm | 10 | 10 | 10 | 10 |
| | W3 | mm | 10 | 10 | 10 | 10 |
| Distance | GL0/(TL/2) | % | 50 | 50 | 50 | 50 |
| | GL1/(TL/2) | % | 10 | 10 | 10 | 10 |
| | GL2/(TL/2) | % | 25 | 25 | 25 | 25 |
| | GL3/(TL/2) | % | 65 | 65 | 65 | 65 |
| Lug groove | Length L0/TL | % | 2 | 0.1 | 3 | 8 |
| | Length L0a/RW1 | % | 15 | 15 | 15 | 15 |
| | Length L0b/RW2 | % | 25 | 25 | 25 | 25 |
| | Shape | | Curved | Curved | Curved | Curved |
| | Radius of curvature R | mm | 55 | 10 | 10 | 10 |
| Dry | Steering stability | | 8 | 8 | 8 | 7 |
| performance | performance | | | | | |
| | Travel time | Index | 105 | 105 | 105 | 103 |
| | | value | | | | |
| Wet | Steering stability | | 7 | 7 | 8 | 8 |
| performance | performance | | | | | |
| | Hydroplaning | Index | 103 | 103 | 104 | 104 |
| | resistance performance | value | | | | |

| | | | | | |
|---|---|---|---|---|---|
| Uneven wear resistance performance | | 8 | 8 | 9 | 9 |
| Noise performance | Index | 101 | 101 | 102 | 102 |
| | value | | | | |

As is clear from Tables 1 and 2, the Examples 1 to 14 all had a better balance between dry performance, wet performance, uneven wear resistance performance, and noise performance than Conventional Example 1.

Comparative Example 1 had an excessively small groove width for the narrow groove. This resulted in hydroplaning resistance performance degrading and an insufficient improvement in steering stability on wet road surfaces. Comparative Example 2 had an excessively large groove width for the narrow groove. This resulted in no improvement in noise performance and uneven wear resistance performance degrading.

1. A pneumatic tire with a specified mounting direction with respect to a vehicle, the pneumatic tire comprising:
an annular tread portion that extends in a tire circumferential direction;
a pair of sidewall portions disposed on opposite sides of the tread portion;
a pair of bead portions disposed inward in a tire radial direction of the pair of sidewall portions;
a narrow groove disposed on a vehicle outer side of a tire equator in the tread portion extending in the tire circumferential direction, wherein the narrow groove has a groove width of from 1 mm to 6 mm; and
a plurality of lug grooves disposed in the tread portion that intersect with the narrow groove and include terminating ends on opposite sides, wherein the plurality of lug grooves are each curved toward one side in the tire circumferential direction.

2. The pneumatic tire according to claim 1, further comprising a first main groove disposed on the tire equator of the tread portion or on the vehicle outer side of the tire equator at a position on a vehicle inner side of the narrow groove, wherein the first main groove extends in the tire circumferential direction and has a larger groove width than the narrow groove.

3. The pneumatic tire according to claim 2, wherein the groove width of the narrow groove is from 10% to 60% of the groove width of the first main groove.

4. The pneumatic tire according to claim 2, wherein the groove width of the first main groove is from 8 mm to 16 mm.

5. The pneumatic tire according to claim 1, a curved portion of the lug groove has a radius of curvature of from 8 mm to 50 mm.

6. The pneumatic tire according to claim 1, wherein a length in a tire width direction of the lug groove is from 1% to 6% of a ground contact width of the tread portion.

7. The pneumatic tire according to claim 1, further comprising a second main groove disposed on the vehicle inner side of the tire equator in the tread portion extending in the tire circumferential direction, and a third main groove disposed on the vehicle inner side of the second main groove in the tread portion extending in the tire circumferential direction.

8. The pneumatic tire according to claim 7, wherein the second main groove and the third main groove have a groove width of from 8 mm to 16 mm.

9. The pneumatic tire according to claim 3, wherein the groove width of the first main groove is from 8 mm to 16 mm.

10. The pneumatic tire according to claim 9, a curved portion of the lug groove has a radius of curvature of from 8 mm to 50 mm.

11. The pneumatic tire according to claim 10, wherein a length in a tire width direction of the lug groove is from 1% to 6% of a ground contact width of the tread portion.

12. The pneumatic tire according to claim 11, further comprising a second main groove disposed on the vehicle inner side of the tire equator in the tread portion extending in the tire circumferential direction, and a third main groove disposed on the vehicle inner side of the second main groove in the tread portion extending in the tire circumferential direction.

13. The pneumatic tire according to claim 12, wherein the second main groove and the third main groove have a groove width of from 8 mm to 16 mm.
